(19) United States
(12) Patent Application Publication
(10) Pub. No.: US 2011/0266222 A1
(43) Pub. Date: Nov. 3, 2011

(54) POLYBENZIMIDAZOLE-BASED MEMBRANES FOR THE DEHYDRATION OF ORGANIC LIQUIDS VIA PERVAPORATION

(76) Inventors: Yan WANG, Chaohu City (CN); Michael Gruender, Charlotte, NC (US); Tai-shung Chung, Ann Arbor, MI (US)

(21) Appl. No.: 13/092,185

(22) Filed: Apr. 22, 2011

Related U.S. Application Data
(60) Provisional application No. 61/329,142, filed on Apr. 29, 2010.

(51) Int. Cl. B01D 69/08; B01D 61/14; B05D 7/22; B01D 63/04

(52) U.S. Cl. 210/650; 210/500.23; 210/321.88; 427/238

(57) ABSTRACT

A hollow fiber membrane has an outer layer of polybenzimidazole (PBI) and an inner support layer, e.g., polyetherimide (PEI). The hollow fiber membrane is made by a co-extrusion (spinning) process. The hollow fiber membrane may be used in a pervaporation process, such as a pervaporation dehydration of an organic liquid, e.g., ethylene glycol (EG). A contactor is made with the hollow fiber membrane.

### RELATED APPLICATION

The instant application claims the benefit of co-pending U.S. Provisional Patent Application Ser. No. 61/329,142 filed Apr. 29, 2010.

### FIELD OF THE INVENTION

The instant invention is directed to hollow fiber membranes with an outer layer of polybenzimidazole and an inner support layer, the method of making the hollow fiber membrane, and the use of the membrane in pervaporation processes.

### BACKGROUND OF THE INVENTION

Pervaporation is a process for the separation of liquid mixtures by partial vaporization through a membrane. The separation process has two steps: first, one component of the mixture permeates away from the mixture through the membrane (the escaping component is called the permeate, and the remaining mixture is called the retentate); and second, the permeate evaporates away from the membrane. Pervaporation, Wikipedia (Mar. 10, 2010).

The efficacy of the pervaporation membrane may be determined by the membrane's selectivity (expressed as separation factor) and productivity (expressed as flux). Flux refers to the rate of flow or transfer of permeate from the mixture to vapor, and denotes a quantity of permeate that crosses a unit of area of a given surface in a unit of time. Separation factor refers to the membrane's ability to selectively remove more of one mixture component than the other component(s) of the mixture. Productivity and selectivity are membrane-dependent. Membrane technology, © 1998-2009 Lenntech Water Treatment & Purification Holding B. V., Delft, the Netherlands (www.lenntech.com).

In Dehydration of tetrafluoropropanol (TFP) by pervaporation via novel PBI/BTDA-TDI/MDI co-polyimide (P84) dual-layer hollow fiber membranes, J. Membrane Sci. 287 (2007) 60-66 by K. Y. Wang, T.-S. Chung, & R. Rajagapalan, a dual-layer PBI (outer layer)/P84 co-polyimide (inner support layer) hollow fiber pervaporation membrane is used to dehydrate tetrafluoropropanol (TFP).

In Enhanced Matrimid membranes for pervaporation by homogenous blends with polybenzimidazole (PBI), J. Membrane Sci. 271 (2006)221-231 by T.-S. Chung, W. F. Guo, and Y. Liu, a pervaporation membrane consisting of a blend of Matrimid and a small amount of PBI is used to dehydrate an organic liquid (tert-butanol).

In U.S. Pat. Nos. 6,623,639 and 6,986,844, a membrane consisting of a PEI (polyetherimide)/PVA (polyvinyl alcohol) outer permselective layer and a PBI microporous inner support layer is used to de-water a feed stream.

In U.S. Pat. No. 4,973,630, miscible blends of PBI and PEI are disclosed for use as coatings, films, molding compositions, and the like.

There is an ongoing need to investigate new membranes and their efficacy in various pervaporation processes. Specifically, there is a need to investigate new membranes for use in the pervaporation dehydration of ethylene glycol.

### SUMMARY OF THE INVENTION

A hollow fiber membrane has an outer layer of polybenzimidazole (PBI) and an inner support layer, e.g., polyetherimide (PEI). The hollow fiber membrane is made by a co-extrusion (spinning) process. The hollow fiber membrane may be used in a pervaporation process, such as a pervaporation dehydration of an organic liquid, e.g., ethylene glycol (EG). A contactor is made with the hollow fiber membrane.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a representation of an exemplary hollow fiber.

FIG. 2a is a representation of an exemplary polybenzimidazole molecule.

FIG. 2b is a representation of an exemplary polyetherimide molecule.

FIG. 3 is a comparison of various membranes used for the pervaporation dehydration of ethylene glycol.

FIGS. 4a and 4b are illustrations of a spinneret that may be used to spin the instant hollow fiber.

FIGS. 5a and 5b are illustrations of exemplary contactors employing the inventive hollow fibers.

FIGS. 6a-f are photomicrographs of the instant hollow fiber.

FIG. 7a is a graph of total flux and separation factor as a function of temperature.

FIG. 7b is a graph of water flux and ethylene glycol (EG) flux as a function of temperature.

FIG. 8a is a graph of total permeance and selectivity (EG/water) as a function of temperature.

FIG. 8b is a graph of permeance and driving force as a function of temperature.

FIG. 9 is a graph of total flux and separation factor as a function of permeate pressure.

FIG. 10 is a graph of permeance and selectivity as a function of permeate pressure.

FIG. 11a is a graph of water flux and EG flux as a function of EG feed concentration.

FIG. 11b is a graph of water permeance and EG permeance as a function of EG feed concentration.

FIG. 12a is a graph of separation factor as a function of EG feed concentration.

FIG. 12b is a graph of selectivity as a function of EG feed concentration.

### DESCRIPTION OF THE INVENTION

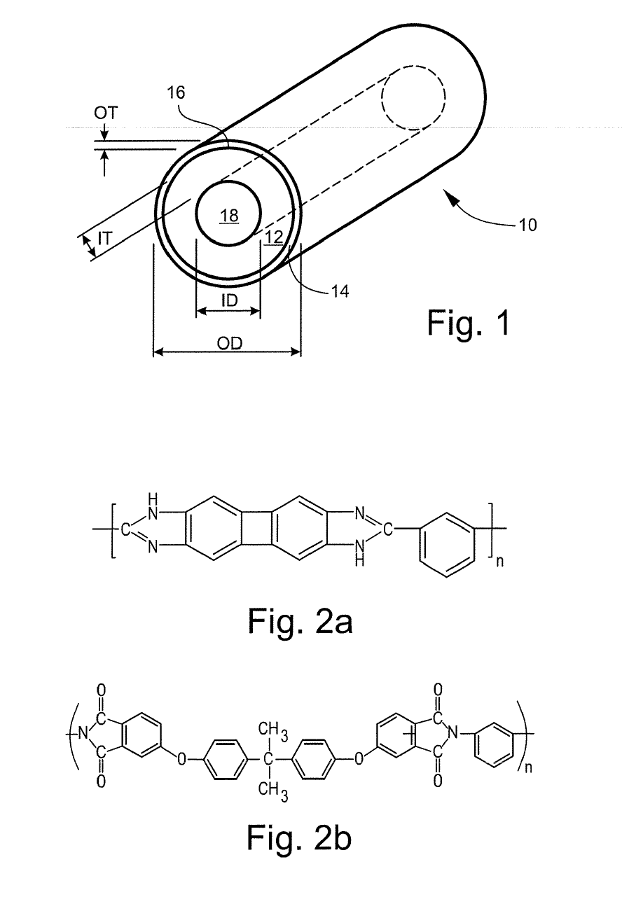

A hollow fiber membrane, as used herein, refers to a multi-layered hollow fiber having at least two (2) layers. The hollow fiber membrane may have two or more layers. In one embodiment, the hollow fiber membrane is a dual-layer hollow fiber membrane. In one embodiment, the hollow fiber membrane is characterized as an asymmetric membrane. In FIG. 1, there is shown a dual layer hollow fiber membrane 10 with an inner layer 12, an outer layer 14, and an interface 16. Layers 12 and 14 are concentric and layer 14 surrounds layer 12. Preferably, at the interface 16, the polymers of the inner layer 12 and the outer layer 14 may knit (or blend) together thereby forming a bond. A lumen 18 is formed within the hollow fiber membrane 10. In some embodiments of the hollow fiber membrane, the inner layer may be a microporous support layer and the outer layer may be a dense permselective layer. In other embodiments of the hollow fiber membrane, the inner layer may be a permselective layer and the outer layer may be a microporous support layer. The term dense, as used herein, indicates that the permselective layer is free of micropores (e.g., no micropores) or substantially free of micropores (e.g., substantially no micropores) when compared with the microporous layer. The hollow fiber membrane has an outside diameter (OD), an inside diameter (ID), an inner layer thickness (IT), and an outer layer thickness (OT). In one embodiment of the instant invention the OD is in the range of 400-1600 microns (μm), preferably 590-1300 microns (μm). In one embodiment of the instant invention the ID is in the range of 250-900 microns (μm), preferably 370-770 microns (μm). In one embodiment of the instant invention the IT is in the range of 50-400 microns (μm), preferably 110-260 microns (μm). In one embodiment of the instant invention the OT is in the range of 1-40 microns (μm), preferably 4-22 microns (μm).

In one embodiment of the hollow fiber membrane, one layer comprises polybenzimidazole (PBI) and the other layer comprises polyetherimide (PEI). In another embodiment, the PBI may comprise the permselective layer and the PEI may comprise the microporous support layer. In another embodiment, the PBI permselective layer may comprise the outer layer and the PEI microporous support layer may comprise the inner layer. Each of these polymers will be discussed in turn below.

Polybenzimidazole (PBI) as used herein refers to PBI, blends of PBI with other polymers, co-polymers of PBI, and combinations thereof. In one embodiment, the PBI component is the major (i.e., at least 50 wt %) component. A representative (nonlimiting) illustration of the PBI molecule is set forth in FIG. 2a. Polybenzimidazole (PBI) refers to, for example, the product of the melt polymerization of an tetraamine (e.g., aromatic and heteroaromatic tetra-amino compounds) and a second monomer being selected from the group consisting of free dicarboxylic acids, alkyl and/or aromatic esters of dicarboxylic acids, alkyl and/or aromatic esters of aromatic or heterocyclic dicarboxylic acid, and/or alkyl and/or aromatic anhydrides of aromatic or heterocyclic dicarboxylic acid. Further details may be obtained from U.S. Pat. Nos. Re 26,065; 4,506,068; 4,814,530; and US Publication No. 2007/0151926, each of which is incorporated herein by reference. PBI is commercially available from PBI Performance Products, Inc. of Charlotte, N.C.

The aromatic and heteroaromatic tetra-amino compounds, used in accordance with the invention, are preferably 3,3′,4,4′-tetra-aminobiphenyl, 2,3,5,6-tetra-aminopyridine, 1,2,4,5-tetra-aminobenzene, 3,3′,4,4′-tetra-aminodiphenylsulfone, 3,3′,4,4′-tetra-aminodiphenyl ether, 3,3′,4,4′-tetra-aminobenzophenone, 3,3′,4,4′-tetra-aminodiphenyl methane, and 3,3′,4,4′-tetra-aminodiphenyldimethylmethane, and their salts, in particular, their mono-, di-, tri-, and tetrahydrochloride derivatives.

The aromatic carboxylic acids used, in accordance with the invention, are dicarboxylic acids or its esters, or its anhydrides or its acid chlorides. The term “aromatic carboxylic acids” equally comprises heteroaromatic carboxylic acids as well. Preferably, the aromatic dicarboxylic acids are isophthalic acid, terephthalic acid, phthalic acid, 5-hydroxyisophthalic acid, 4-hydroxyisophthalic acid, 2-hydroxyterephthalic acid, 5-aminoisophthalic acid, 5-N,N-dimethylaminoisophthalic acid, 5-N,N-diethylaminoisophthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 3-fluorophthalic acid, 5-fluoroisophthalic acid, 2-fluoroterephthalic acid, tetrafluorophthalic acid, tetrafluoroisophthalic acid, tetrafluoroterephthalic acid, 1,4-naphthalenedicarboxylic acid, 1,5-naphthalenedicarboxylic acid, 2,6-naphthalenedicarboxylic acid, 2,7-napthalenedicarboxylic acid, diphenic acid, 1,8-dihydroxynaphthalene-3,6-dicarboyxlic acid, diphenyl ether-4,4′-dicarboxylic acid, benzophenone-4,4′-dicarboxylic acid, diphenylsulfone-4,4′-dicarboyxlic acid, biphenyl-4,4′-dicarboxylic acid, 4-trifluoromethylphthalic acid, 2,2-bis(4-carboxyphenyl)hexafluoropropane, 4,4′-stilbenedicarboxylic acid, 4-carboxycinnamic acid, or their C1-C20-alkyl esters or C5-C12-aryl esters, or their acid anhydrides or their acid chlorides.

The heteroaromatic carboxylic acids used, in accordance with the invention, are heteroaromatic dicarboxylic acids or their esters or their anhydrides. The “heteroaromatic dicarboxylic acids” include aromatic systems that contain at least one nitrogen, oxygen, sulfur, or phosphorus atom in the ring. Preferably, it is pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridine dicarboxylic acid, 3,5-pyrazole dicarboxylic acid, 2,6-pyrimidine dicarboxylic acid, 2,5-pyrazine dicarboxylic acid, 2,4,6-pyridine tricarboxylic acid, and benzimidazole-5,6-dicarboxylic acid, as well as their C1-C20-alkyl esters or C5-C12-aryl esters, or their acid anhydrides or their acid chlorides.

The aromatic and heteroaromatic diaminocarboxylic acid used in accordance with the invention is preferably diaminobenzoic acid and its mono- and dihydrochloride derivatives.

Preferably, mixtures of at least 2 different aromatic carboxylic acids are used. These mixtures are, in particular, mixtures of N-heteroaromatic dicarboxylic acids and aromatic dicarboxylic acids or their esters. Non-limiting examples are isophthalic acid, terephthalic acid, phthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynapthalene-3,6-dicarboxylic acid, diphenyl ether-4,4′-dicarboxylic acid, benzophenone-4,4′-dicarboxylic acid, diphenylsulfone-4,4′-dicarboxylic acid, biphenyl-4,4′-dicarboxylic acid, 4-trifluoromethylphthalic acid, pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidine dicarboxylic acid, and 2,5-pyrazine dicarboxylic acid. Preferably, it is the diphenyl isophthalate (DPIP) and its ester.

Examples of polybenzimidazoles which may be prepared according to the process as described above include:
poly-2,2′-(m-phenylene)-5,5′-bibenzimidazole;
poly-2,2′-(biphenylene-2″2′″)-5,5′-bibenzimidazole;
poly-2,2′-(biphenylene-4″4′″)-5,5′-bibenzimidazole;
poly-2,2′-(1″,1″,3″trimethylindanylene)-3″5″-p-phenylene-5,5′-bibenzimidazole;
2,2′-(m-phenylene)-5,5′-bibenzimidazole/2,2-(1″,1″,3″-trimethylindanylene)-5″,3″-(p-phenylene)-5,5′-bibenzimidazole copolymer;
2,2′-(m-phenylene)-5,5-bibenzimidazole-2,2′-biphenylene-2″,2″-5,5′-bibenzimidazole copolymer;
poly-2,2′-(furylene-2″,5″)-5,5′-bibenzimidazole;
poly-2,2′-(naphthalene-1″,6″)-5,5′-bibenzimidazole;
poly-2,2′-(naphthalene-2″,6″)-5,5′-bibenzimidazole;
poly-2,2′-amylene-5,5′-bibenzimidazole;
poly-2,2′-octamethylene-5,5′-bibenzimidazole;
poly-2,2′-(m-phenylene)-diimidazobenzene;
poly-2,2′-cyclohexenyl-5,5′-bibenzimidazole;
poly-2,2′-(m-phenylene)-5,5′-di(benzimidazole)ether;
poly-2,2′-(m-phenylene)-5,5′-di(benzimidazole)sulfide;
poly-2,2′-(m-phenylene)-5,5′-di(benzimidazole)sulfone;
poly-2,2′-(m-phenylene)-5,5′-di(benzimidazole)methane;
poly-2,2″-(m-phenylene)-5,5″-di(benzimidazole)propane-2,2; and
poly-ethylene-1,2-2,2″-(m-phenylene)-5,5″-dibenzimidazole)ethylene-1,2
   where the double bonds of the ethylene groups are intact in the final polymer. Poly-2,2′-(m-phenylene)-5,5′-bibenzimidazole, a preferred polymer, can be prepared by the reaction of 3,3′,4,4′-tetraminobiphenyl with a combination of isophthalic acid with diphenyl isophthalate or with a dialkyl isophthalate such as dimethyl isophthalate; a combination of diphenyl isophthalate and a dialkyl isophthalate such as dimethyl isophthalate; or at least one dialkyl isophthalate such as dimethyl isophthalate, as the sole dicarboxylic component.

Polyetherimide (PEI) as used herein refers to PEI, blends of PEI with other polymers, co-polymers of PEI, and combinations thereof. In one embodiment, the PEI component is the major (i.e., at least 50 wt %) component. A representative (nonlimiting) illustration of the PEI molecule is set for the in FIG. 2b. While any PEI may be used in the instant application the ULTEM® polyetherimides (homopolymer and co-polymer) commercially available from SABIC (formerly GE Plastics) are preferred.

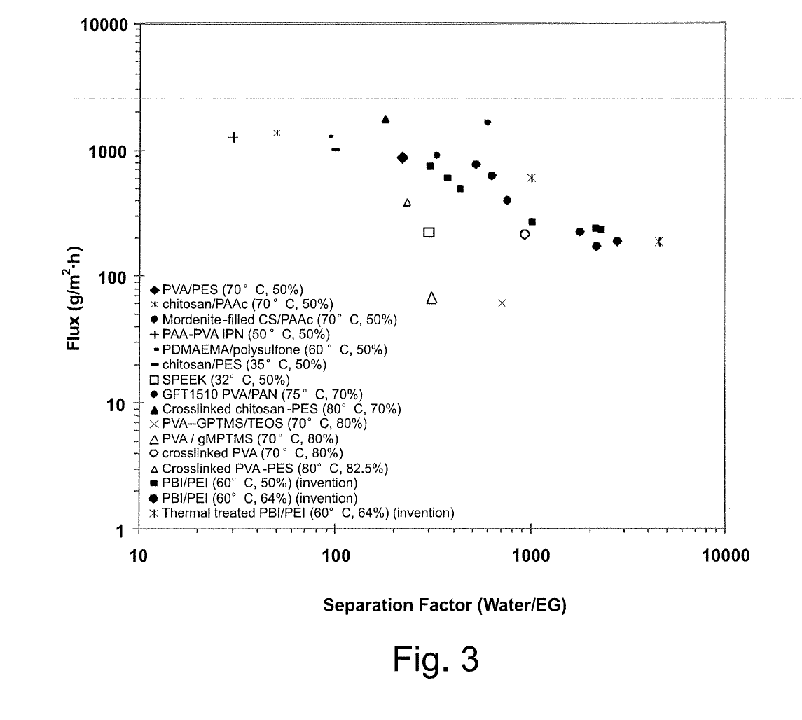

In one embodiment of the hollow fiber membrane where the outer layer is a permselective layer of PBI and the inner layer is a microporous support layer of PEI, the hollow fiber membrane has a flux (for separating water and ethylene glycol) in the range of 200-800 g/m² h, and a separation factor (for separating water and ethylene glycol) in the range of 300-2500; and more specifically for the pervaporation dehydration of a feed system of 50/50 wt % water/ethylene glycol mixture at 60° C. under a permeate pressure of less than 5 mbar, the hollow fiber membrane has a flux (for separating water and ethylene glycol) in the range of 200-800 g/m² h, and a separation factor (for separating water and ethylene glycol) in the range of 300-2500. In another embodiment of the hollow fiber membrane where the outer layer is a permselective layer of PBI and the inner layer is a microporous support layer of PEI, the hollow fiber membrane has a flux (for separating water and ethylene glycol) in the range of 110-400 g/m² h, and a separation factor (for separating water and ethylene glycol) in the range of 300-1800; and more specifically for the pervaporation dehydration of a feed system of 20/80 wt % water/ethylene glycol mixture at 60° C. under a permeate pressure of less than 5 mbar, the hollow fiber membrane has a flux (for separating water and ethylene glycol) in the range of 110-400 g/m² h, and a separation factor (for separating water and ethylene glycol) in the range of 300-1800. In FIG. 3, there is shown a comparison of the foregoing inventive hollow fiber membrane in comparison with other membranes used in the pervaporative dehydration of ethylene glycol (EG).

A process for making a hollow fiber membrane with an outer permselective layer of PBI and inner microporous support layer of PEI may generally comprise the steps of: extruding a PBI dope and a PEI dope through a spinneret with a bore quench mechanism, injecting a bore quench fluid through the bore quench mechanism while extruding the PBI and PEI dopes, passing the nascent hollow fiber through an air gap defined between the spinneret and a coagulation bath, submerging the nascent hollow fiber into the coagulation bath, and taking up the nascent hollow fiber membrane. In another embodiment, the process further includes the step of the heat treating (or annealing) the nascent hollow fiber after take up.

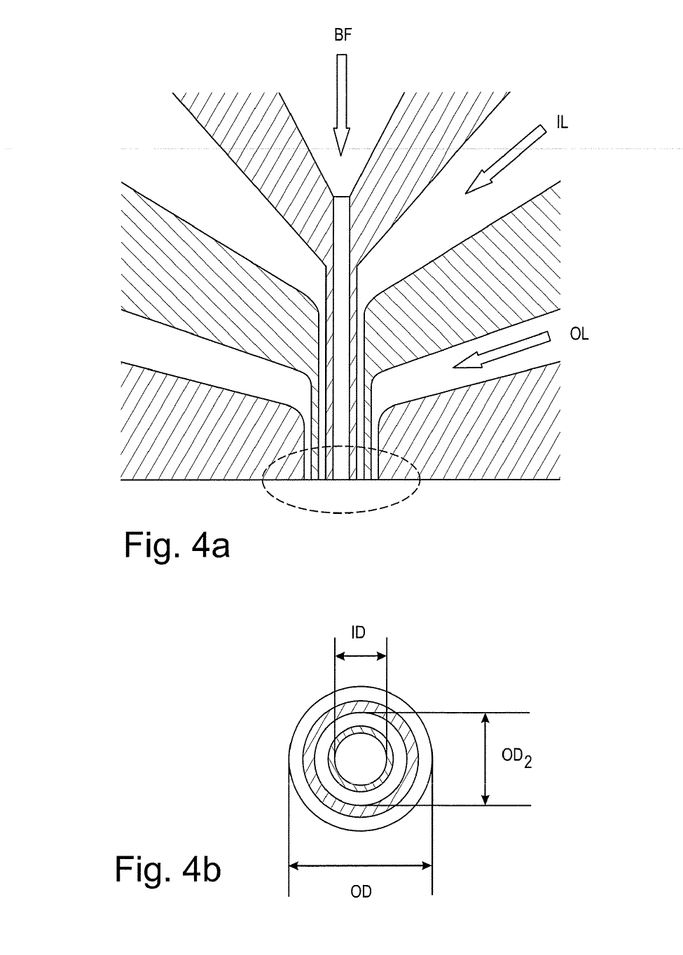

The spinneret with the bore quench mechanism, in one embodiment, is illustrated in FIGS. 4a and 4b. Bore quench fluid (BF) is injected through a central channel with the inner layer dope (IL) being injected through the next concentric (annular) channel and the outer layer fluid being injected through the outermost concentric (annular) channel.

The air gap, in one embodiment, may be in the range of 1-10 cm. In another embodiment, the air gap is in the range of 1-5 cm.

The take-up speed, in one embodiment, may be in the range of free fall (about 4.6) to 25 m/min.

The PBI dope, in one embodiment, may be a solution of 20-30 wt % PBI in a solvent. The solvent may be any solvent for PBI, including: N,N-dimethylacetamide (DMAc); N,N-dimethylformamide (DMF), dimethylsulfoxide (DMSO), and N-methyl-2-pyrrolidone (NMP). In one embodiment, the solvent may be N,N-dimethylacetimide (DMAc).

The PEI dope, in one embodiment, may be a solution of 20-30 wt % PEI in a solvent. The solvent may be any solvent for PEI, including: methylene chloride, chloroform, N,N-dimethylformamide, and N,N-dimethylacetimide (DMAc). In one embodiment, the solvent may be N,N-dimethylacetimide (DMAc).

The bore quench fluid, in one embodiment, may be a mixture of solvent and non-solvent for the polymers of the hollow fiber. The solvent may be: N,N-dimethylacetamide (DMAc); N,N-dimethylformamide (DMF), dimethylsulfoxide (DMSO), and N-methyl-2-pyrrolidone (NMP). In one embodiment, the solvent may be N,N-dimethylacetimide (DMAc). The non-solvent may be any non-solvents or mixture of non-solvents. The non-solvent may be: water; acetone; and/or any lower alcohol (e.g., methanol, ethanol, propanol, butanol). In one embodiment, the mixture comprises an 85/15 wt % mixture of solvent/water.

The coagulation bath may comprise any coagulant for the polymers of the hollow fiber. In one embodiment, the bath comprises water.

The heat treatment (or annealing) comprises heating the hollow fiber membranes to a predetermined temperature for a period of time. This heat treatment can promote thermal motion of the polymer chains and their interactions, facilitating chain relaxation and rearrangement towards denser and closer packing of the polymer chains. As a consequence, thermally treated membranes will have a morphology with a smaller free volume and a higher transportation resistance. In one embodiment, the temperature is about 75° C. and time of about 2 hours.

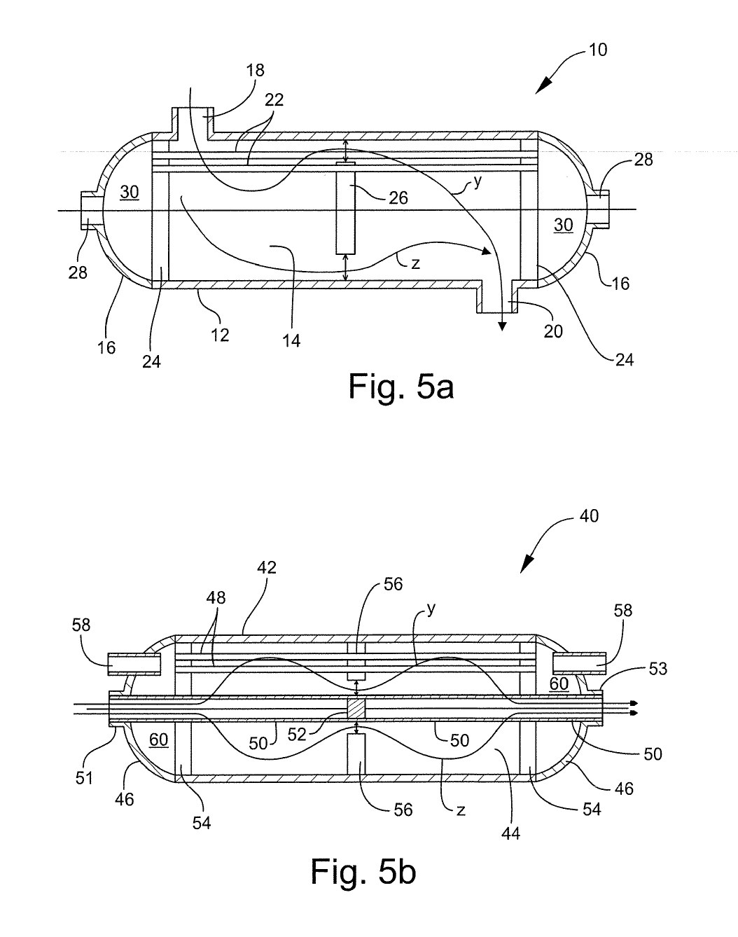

A contactor may be formed using the foregoing hollow fiber membranes. Any contactor may be used. In FIGS. 5a and 5b, there is shown two exemplary and non-limiting embodiments of a contactor for the foregoing hollow fiber membranes. These contactors, along with additional embodiments, are more fully disclosed in U.S. Pat. Nos. 5,264,171 and 5,352,361, which are incorporated herein by reference.

In FIG. 5a, the contactor 10 includes a shell 12, a hollow fiber module 14, and end caps 16. Shell 12 also includes inlet 18 and outlet 20. Module 14 includes a plurality (or bundle) of hollow fiber membranes 22 (only two hollow fiber membranes are shown, but it is understood there are several more filling the shell), tube sheets 24, and a baffle 26 between cap 16 and tube sheet 24. Each end cap 16 includes a port 28 and when the end cap 16 in joined with shell 12, a head space 30 is defined therebetween. The contactor 10 includes a lumen side and a shell side. The lumen side is defined by ports 28, head space 30 and the lumens of the hollow fibers 22. The shell side is defined by inlet 18, a space between inside the shell 12 and between the tube sheets 24 and outside of the hollow fibers 22, and outlet 20. In operation, a vacuum or vacuum/sweep gas may be applied to the lumen side where permeate is removed, and the feed mixture may be introduced into the contactor 10 through the inlet 18 and the retentate is removed at outlet 20. The flow of the feed mixture is indicated by lines z and y.

In FIG. 5b, contactor 40 includes a shell 42, a hollow fiber module 44, and end caps 46. Module 44 includes a plurality (or bundle) of hollow fibers 48 surround (e.g., a fabric of hollow fiber membranes are wound around) a perforated manifold 50 with inlet 51 and outlet 53 and having an internal plug 52, tube sheets 54, and baffle 56. The end caps 46 include ports 58 and when joined with shell 42 define head spaces 60. The contactor 40 includes a lumen side and shell side. The lumen side is defined by ports 58, head space 60 and the lumen side of the hollow fibers 48. The shell side is defined by perforated manifold 50, the space between shell 42, tube sheets 54 and the exterior surfaces of the hollow fibers 48. In operation, a vacuum or vacuum/sweep gas may be applied to the lumen side where permeate is removed, and the feed mixture may be introduced into the contactor 40 through the inlet 51 and the retentate is removed at outlet 53. The flow of the feed mixture is indicated by lines y and z.

A process for the dehydration of an organic liquid via pervaporation generally comprises the steps of: feeding a mixture of water and organic liquid to a first side of a hollow fiber membrane (the hollow fiber membrane having a permselective layer of PBI and a support layer); drawing a vacuum on the other side of the membrane, and collecting a permeate rich in water when compared to the water/organic liquid mixture from the first side of the membrane and a retentate rich in the organic liquid when compared to the water/organic liquid mixture from the second side of the membrane. In one embodiment, hollow fibers are integrated into a contactor. In operation, the water/organic liquid mixture is fed to first (or shell) side of the contactor. A vacuum is drawn on the second (or lumen) side of the contactor. A permeate rich in water when compared to the water/organic liquid mixture is collected from the second side of the membrane and a retentate rich in the organic liquid when compared to the water/organic liquid mixture is collected from the first side of the membrane. The support layer may comprise PEI. In the hollow fiber membrane, the outer layer may be the permselective membrane and the inner layer may be the microporous support layer. In one embodiment, the organic liquid may be ethylene glycol (EG).

The foregoing invention is further explained with reference to the following non-limiting examples.

### EXAMPLES

The dual-layer hollow fiber membranes were made as follows: The outer layer polymer solution (OL), inner layer polymer solution (IL), and bore fluid (BF) were simultaneously extruded (or spun) through a spinneret as shown in FIGS. 4a and 4b (also see: Liu, R. X., et al., Dual-layer P84/polyethersulfone hollow fiber for pervaporation dehydration of isopropanol, J. Membr. Sci. 294 (2007) 103, incorporated herein by reference. Prior to spinning, both polymer solutions were degassed for 24 hours, and both solutions and the bore fluid were filtered through a 15 μm sintered metal filter. The bore fluid consisted of a mixture of 85/15 (w/w) DMAc/water. The outer layer polymer solution (dope) was a 23 wt % PBI polymer solution. This solution was obtained by diluting, with DMAc, a commercially available solution of PBI/DMAc (26.2 wt % PBI, 72.3 wt % DMAc, 1.5 wt % LiCl from PBI Performance Products, Inc of Charlotte, N.C.). The inner layer solution (dope) was a 25 wt % PEI polymer solution consisting of 25/5/70 wt % PEI/PVP/DMAc. The PEI was ULTEM® 1010 polyetherimide available from SABIC (formerly GE Plastics). The PVP (polyvinylpyrrolidone), average M_{w} of 30 kDa, was obtained from Merck of Singapore. After spinning, the nascent hollow fibers passed through an air gap into a coagulant bath (e.g., tap water), are taken-up (e.g., on a drum roll), rinsed [to remove residual solvents (DMAc)] (e.g., for three (3) days in a clean tap water bath), freeze-dried and air dried (naturally), and stored in an ambient environment. Further extrusion (spinning) parameters are set forth in TABLE 1.

TABLE 1

| Parameter | Range of Variables |
|---|---|
| Spinneret dimensions (mm) | OD₁/OD₂/ID (1.20/0.97/0.44) |
| External coagulant | Water |
| Temperature (° C.) | Ambient (23 ± 2) |
| Outer-layer dope flow rate (ml/min) | 0.5 |
| Inner-layer dope flow rate (ml/min) | 4.0 |
| Bore fluid flow rate (ml/min) | 2.0 |

Further, the air gap and take speed where varied as shown in TABLE 2.

TABLE 2

| Membrane | Air Gap Distance (cm) | Take-up speed (m/min) |
|---|---|---|
| A | 5 | 4.60 (free fall) |
| B | 2 | 4.60 (free fall) |
| C | 1 | 4.60 (free fall) |
| D | 2 | 9.59 |
| E | 2 | 16.24 |
| F | 2 | 21.79 |

The pervaporation study was conducted utilizing the apparatus described in Liu, R. X., et al., The development of high performance P84 co-polyimide hollow fibers for pervaporation dehydration of isopropanol, Chem. Eng. Sci. 60 (2005) 6674, incorporated herein by reference. The pervaporation modules were prepared by loading one piece of hollow fiber membrane into a perfluoroalkoxy tubing connected with two SWAGELOK® stainless steel male run tees with an effective length of about 20 cm. Both ends were sealed with epoxy and cured for 24 h at ambient temperature. Any thermal treatment of the fiber was completed before module fabrication. The feed solution consisted of a 50/50 wt % water/ethylene glycol mixture (concentration variance of less than 0.5 wt %). The operational temperature was 60° C. The feed flow rate was 0.5 l/min. The permeate pressure was less than 3 mbar (maintained by vacuum pump). Retentate and permeate samples were collected after the membrane was conditioned for about 2 h. The flux J was determined by the mass of permeate divided by the product of the time interval and membrane area. The separation factor α is defined by equation (1) below:

α=(y_{w1}/y_{w2})/(x_{w1}/x_{w2}) (1)

Where: subscripts 1 and 2 refer to water and ethylene glycol, respectively; y_{w} and x_{w} are the weight fractions of the component in the permeate and feed and were analyzed through a Hewlett-Packard GC 7890A with a HP-INNOWAX column (packed with cross-linked polyethylene glycol) and a TCD detector. The results for the foregoing membranes (i.e., those in TABLE 2) are set forth in TABLE 3. TABLE 3 additionally sets forth the relevant spinning parameters to illustrate the affect that those parameters have on the flux and separation factor.

TABLE 3

| | | T-U | | | OL | Permeate | | |
|---|---|---|---|---|---|---|---|---|
| | Gap | Speed | OD | ID | Thick | (H₂0 | J | |
| ID | (cm) | (m/min) | (μm) | (μm) | (μm) | wt %) | (g/m²h) | α |
| A | 5 | 4.60 | 1222 | 721 | 14.2 | 99.93 | 232 | 2156 |
| B | 2 | 4.60 | 1229 | 752 | 17.5 | 99.96 | 241 | 2288 |
| C | 1 | 4.60 | 1226 | 725 | 14.6 | 99.90 | 266 | 1016 |
| D | 2 | 9.59 | 899 | 589 | 9.5 | 99.76 | 492 | 436 |
| E | 2 | 16.24 | 686 | 425 | 5.2 | 99.72 | 596 | 373 |
| F | 2 | 21.79 | 597 | 376 | 4.8 | 99.67 | 732 | 303 |

Gap refers to air gap.
T-U Speed refers to Take-up speed.
OD refers to the outside diameter of the hollow fiber membrane.
ID refers to the inside diameter of the hollow fiber membrane.
OL Thick refers to the outside layer thickness.

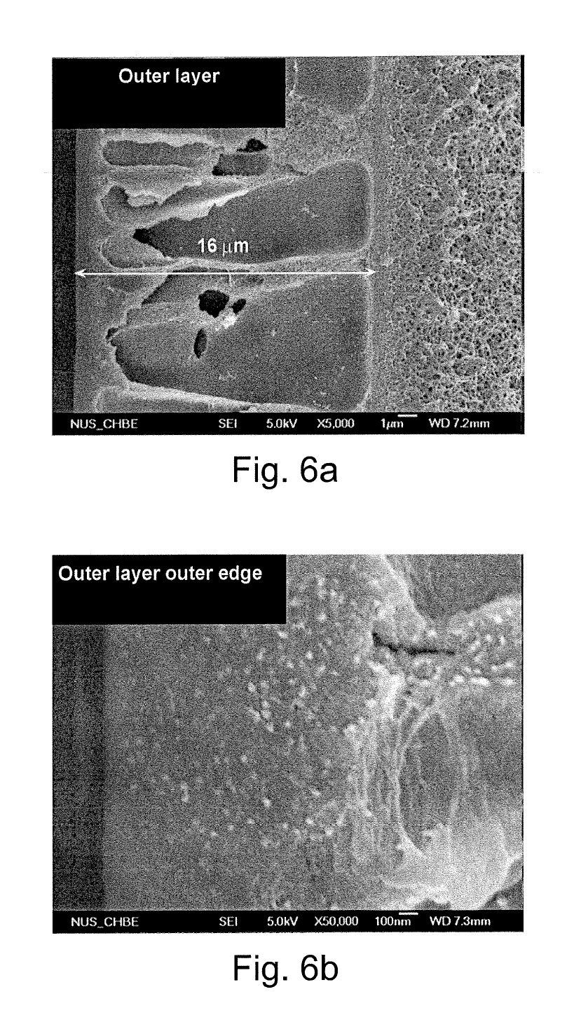

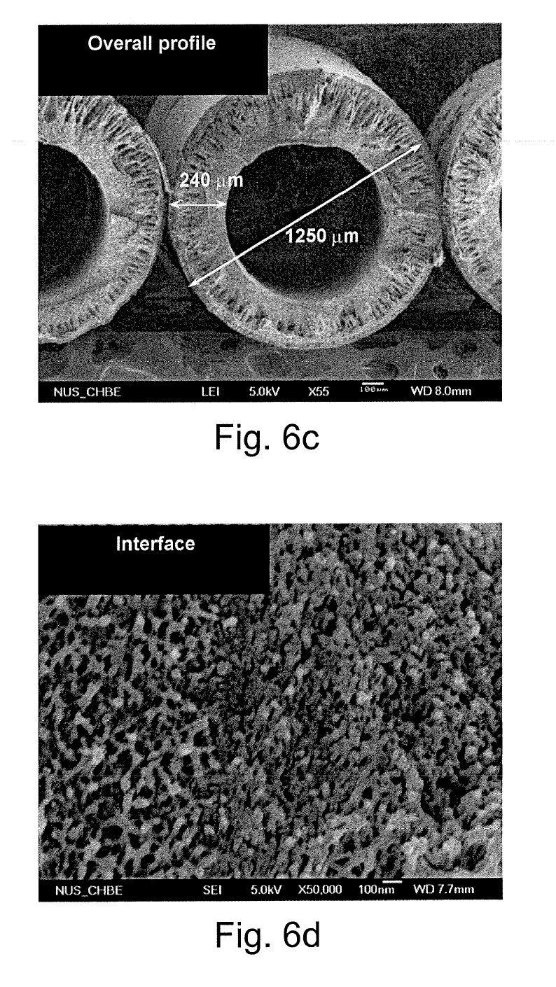

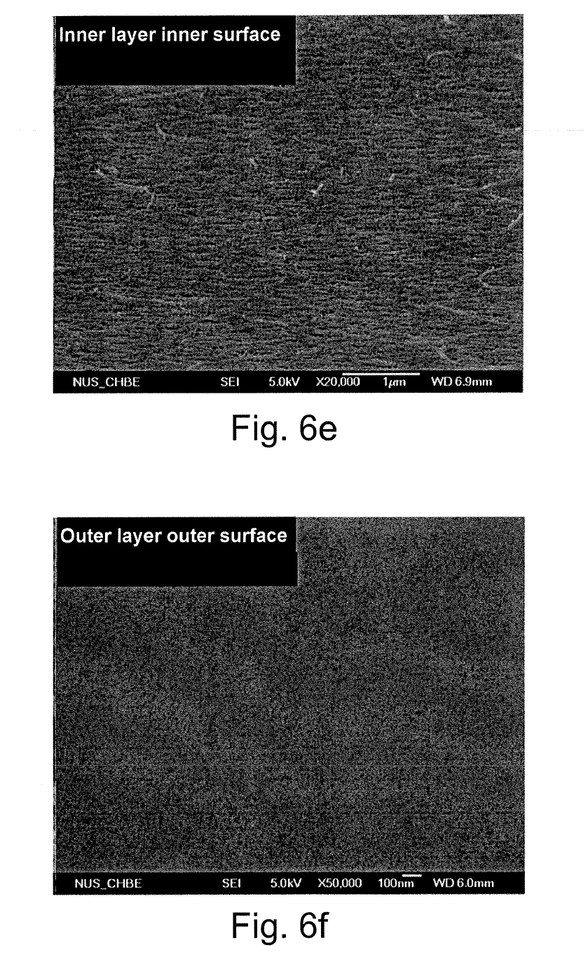

The morphology of the hollow fiber membranes was observed using a JSM-6700F field emission scanning electron microscope (FESEM). The hollow fiber sample of the SEM observation was prepared by fracturing the membrane in liquid nitrogen and then coating the membrane with platinum. The result for membrane B are set forth in FIG. 6a-f, which are: a) outer layer, b) outer layer outer edge, c) overall profile, d) interface, e) inner layer inner surface, and f) outer layer outer surface.

The mechanical properties of the hollow fibers were tested using a tensile meter INSTRON 5542 and analyzed with the Bluehill 2 software. The tests were conducted at room temperature (25° C.) and 80% relative humidity. Each hollow fiber sample was clamped at the both ends with an initial gauge length of 50 mm and the test method involved stretching at a rate of 10 ram/min until failure. At least three samples were tested for each membrane. The results are set forth in TABLE 4.

TABLE 4

| | Max. tensile | Young's Modulus | Max. Strain |
|---|---|---|---|
| ID | stress (MPa) | (MPa) | (mm/mm) |
| A | 11.1 | 417 | 0.23 |
| B | 12.7 | 423 | 0.21 |
| C | 11.0 | 436 | 0.20 |
| D | 9.4 | 325 | 0.24 |
| E | 12.7 | 527 | 0.25 |
| F | 13.2 | 600 | 0.28 |

The effect of heat treating (annealing) the hollow fiber on flux and separation factor was studied. The flux and separation factor, before and after heat treatment, is presented in TABLE 5. Heat treatment refers to heating at 75° C. for 2 h. The feed composition was ethylene glycol/water (64/36 wt %).

TABLE 5

| | Permeate | J | |
|---|---|---|---|
| ID | (H2O, wt %) | (g/m2 h) | α |
| C | 99.74 | 222 | 1047 |
| C annealed | 99.96 | 186 | 4524 |
| F | 99.69 | 758 | 592 |
| F annealed | 99.81 | 597 | 1004 |

In the following examples, the effects of operation conditions on pervaporation performance of the membrane were studied as follows: 1) the effect of operational temperature under constant permeate pressure of 2 mbar; 2) the effect of permeate pressure under a constant temperature of 60° C.; and 3) the stability of long-term performance under a constant temperature of 60° C. and a permeate pressure of 2 mbar. Unless specified, a binary mixture containing 80/20 wt % EG/water was chosen as the feed for the above study. In addition, we varied feed composition and studied its effect under a constant temperature of 60° C. and permeate pressure of less than 5 mbar. Membranes A and B were tested, but only the results of B are presented in view of the close similarity of results. Permeance (or permeability) is related to flux, but permeance is better suited for the evaluation of the intrinsic properties of the specific permeant-membrane system since they significantly decouple the effect of process parameters on performance evaluation. The membrane permeance is defined as follows:

$${\overline{P}}_{i} = \frac{{P}_{i}}{l} = \frac{{J}_{i}}{{x}_{n , i} {γ}_{i} {p}_{i}^{sat} - {y}_{n , i} {p}^{p}} \qquad ( 2 )$$

where Pᵢ is the membrane permeability of the component i, a product of diffusivity and solubility coefficients, l is the membrane thickness, x_{n,i} and y_{n,i} are the mole fractions of the component i in the feed and permeate, γᵢ is the activity coefficient, pᵢ^{sat} is the saturated vapor pressure, and p^{p} is the permeate pressure. pᵢ^{sat} and γᵢ can be calculated by the Wilson equation and Antoine equation respectively, and obtained with the aid of the AspenTech DISTIL software provided by Hyprotech Ltd, Canada. Likewise, selectivity is related to separation factor. The ideal membrane selectivity β is therefore defined as the ratio of permeability coefficients or permeance of the two components.

$${β}_{1 / 2} = \frac{{P}_{1}}{{P}_{2}} or \frac{{\overline{P}}_{1}}{{\overline{P}}_{2}} \qquad ( 3 )$$

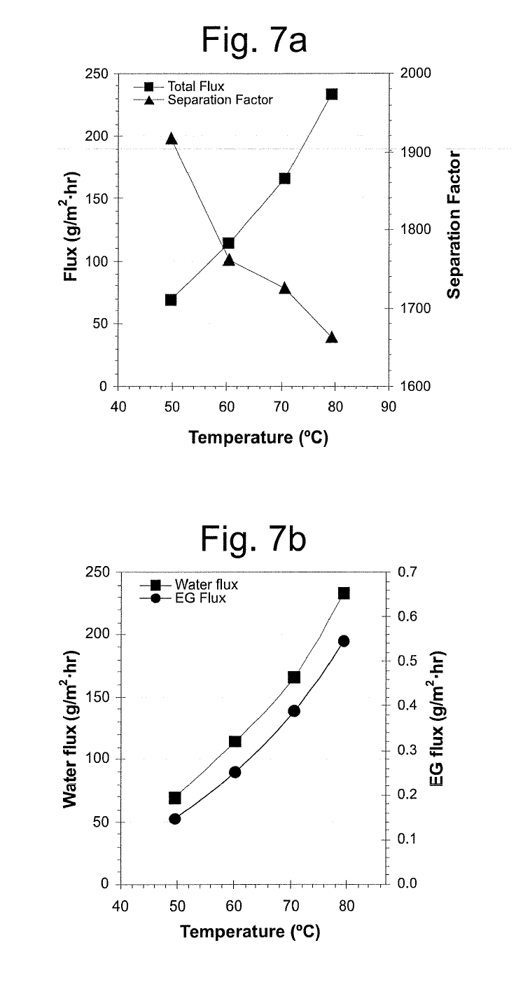

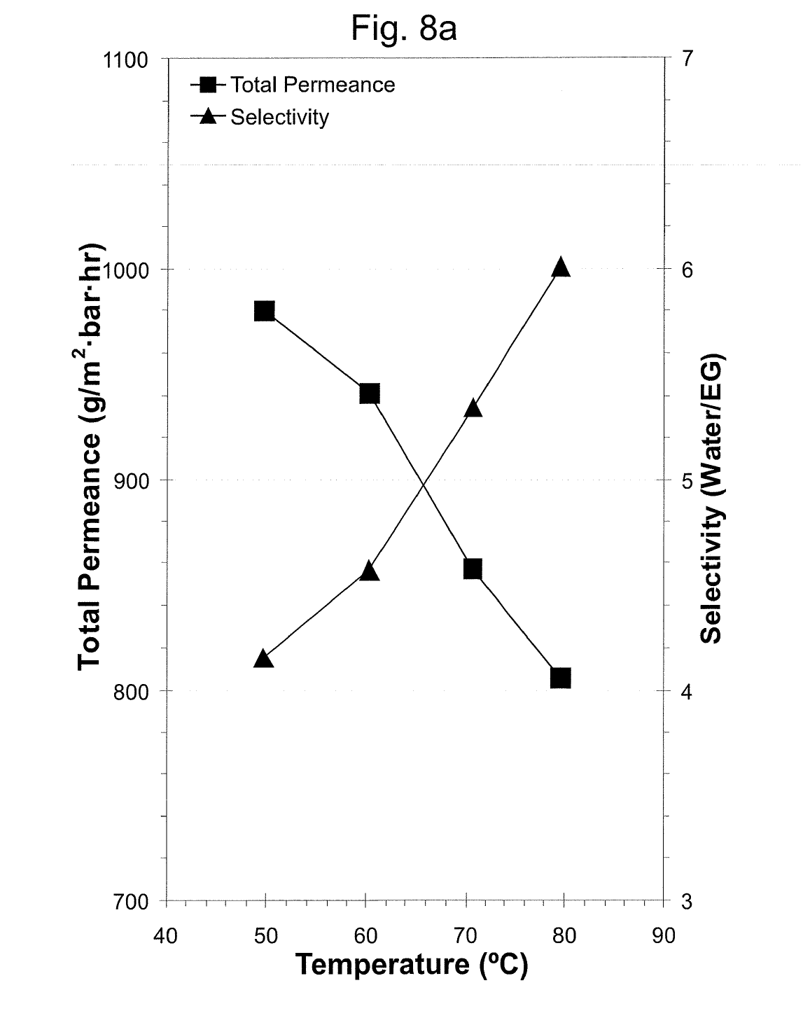

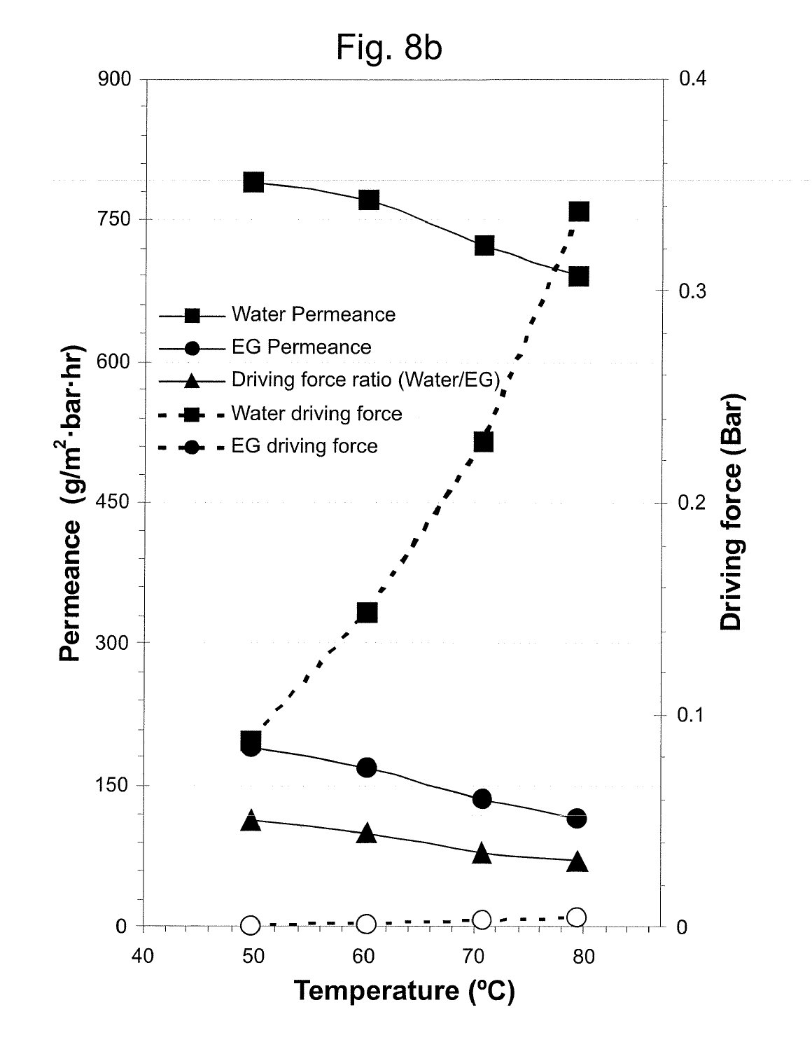

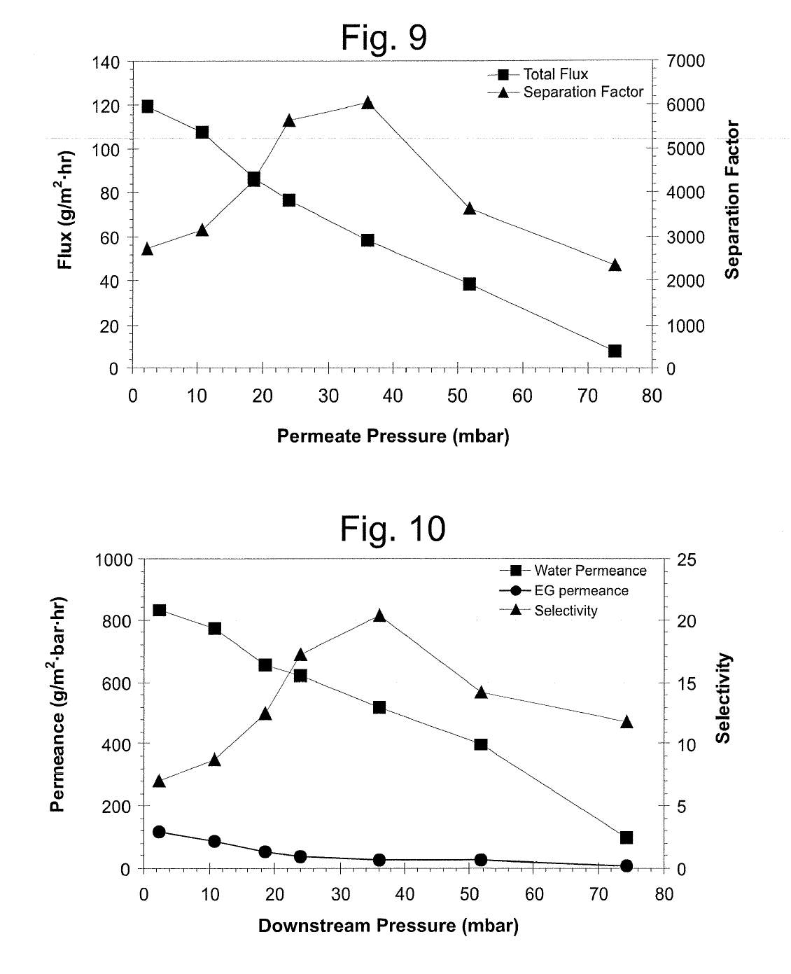

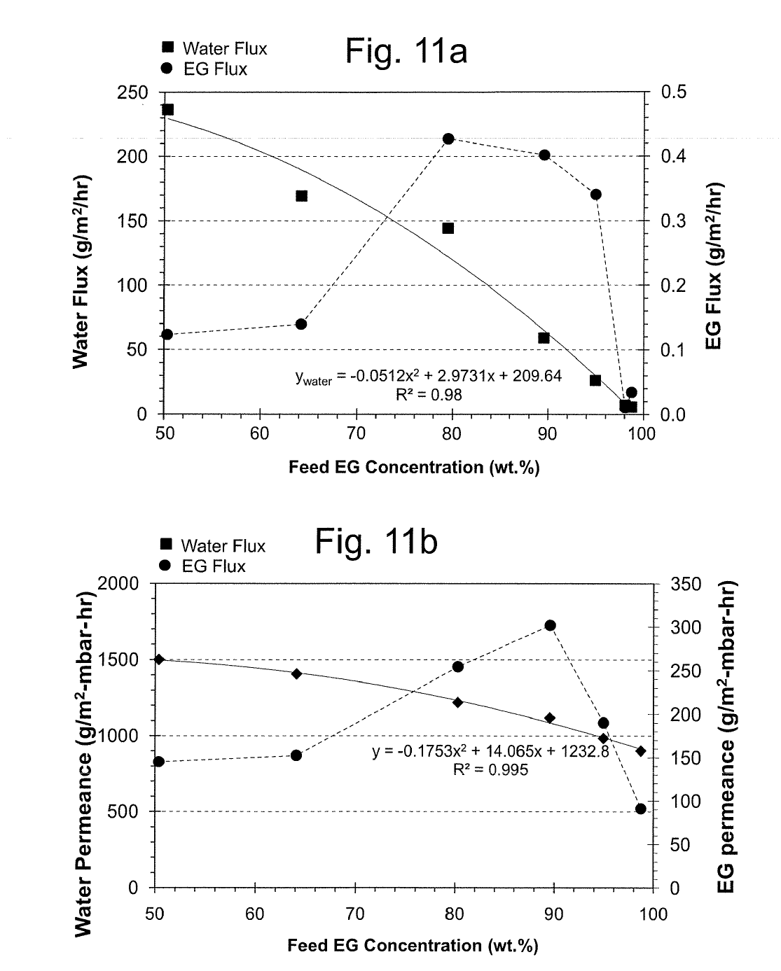

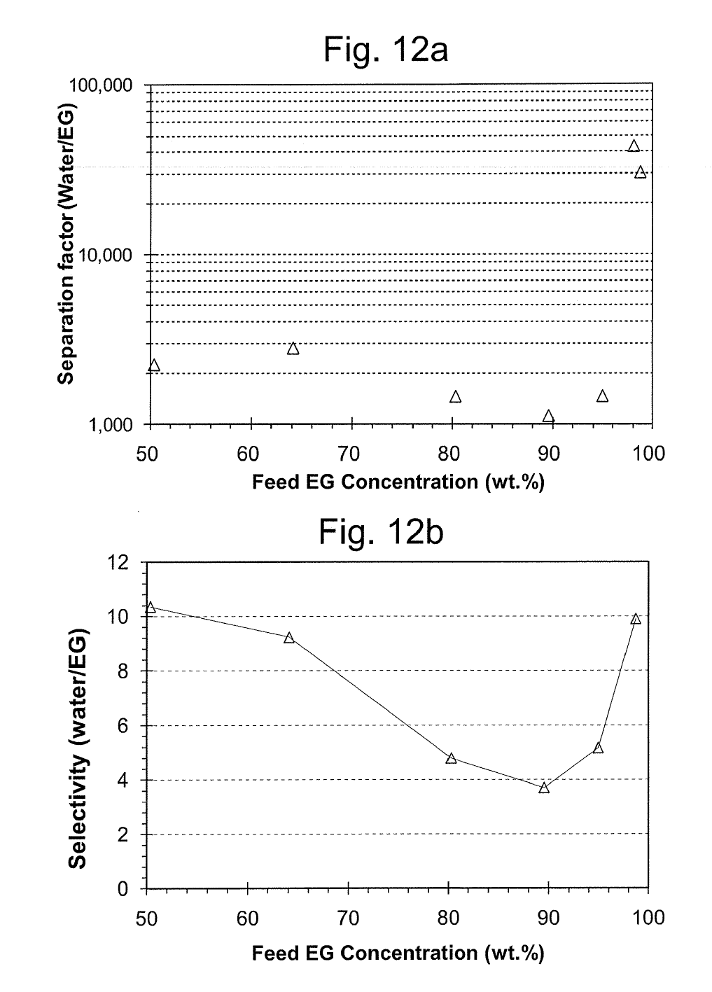

For a more thorough examination of the relationship between these parameters, reference is made to Wang, Y. et al., Processing and engineering of pervaporation dehydration of ethylene glycol via dual-layer polybenzimidazole (PBI)/polyetherimide (PEI) membranes, (Unpublished). FIG. 7a shows a relationship between total flux and separation factor as a function of temperature. FIG. 7b shows a relationship between water flux and ethylene glycol (EG) flux as a function of temperature. FIG. 8a shows a relationship between total permeance and selectivity (water/EG) as a function of temperature. FIG. 8b shows a relationship between permeance and driving force as a function of temperature. FIG. 9 shows a relationship between total flux and separation factor as a function of permeate pressure. FIG. 10 shows a relationship between permeance and selectivity as a function of permeate pressure. FIG. 11a shows a relationship between water flux and EG flux as a function of EG feed concentration. FIG. 11b shows a relationship between water permeance and EG permeance as a function of EG feed concentration. FIG. 12a shows a relationship between separation factor as a function of EG feed concentration. FIG. 12b shows a relationship between selectivity as a function of EG feed concentration.

The present invention may be embodied in other forms without departing from the spirit and the essential attributes thereof, and, accordingly, reference should be made to the appended claims, rather than to the foregoing specification, as indicated the scope of the invention.

We claim:

1. A hollow fiber membrane comprising:
an inner microporous support layer of a polyetherimide (PEI); and
an outer permselective layer of a polybenzimidazole (PBI).

2. The hollow fiber membrane of claim 1 wherein said support layer being an inner layer and said permselective layer being an outer layer.

3. The hollow fiber membrane of claim 1 wherein said permselective layer being free of micropores or substantially free of micropores when compared to said microporous support layer.

4. The hollow fiber membrane of claim 1 wherein the hollow fiber membrane having: an outside diameter (OD) in the range of 590-1300 microns (μm); an inside diameter (ID) in the range of 370-770 μm; a support layer thickness in the range of 110-260 μm; and a permselective layer thickness in the range of 1-40 μm.

5. The hollow fiber membrane of claim 1 wherein the hollow fiber membrane having: a flux in the range of 200-800 g/m²·h; and a separation factor for removing water from ethylene glycol (EG) in the range of 300-2500.

6. The hollow fiber membrane of claim 1 wherein the hollow fiber membrane having: a flux in the range of 110-400 g/m²·h; and a separation factor for removing water from ethylene glycol (EG) in the range of 300-1800.

7. A process for making a hollow fiber membrane with a PBI outer layer and a PEI inner layer comprising the steps of:
extruding a PBI dope and a PEI dope through a spinneret with a bore quench mechanism,
injecting a bore quench fluid through said bore quench mechanism while extruding the PBI and PEI dopes,
passing the nascent hollow fiber membrane through an air gap defined between the spinneret and a coagulation bath,
submerging the nascent hollow fiber membrane into the coagulation bath, and
taking up the nascent hollow fiber membrane.

8. The process for making a hollow fiber membrane with a PBI outer layer and a PEI inner layer according to claim 7 further comprising the step of annealing the hollow fiber after take up.

9. The process for making a hollow fiber membrane with a PBI outer layer and a PEI inner layer according to claim 7 wherein the air gap being in the range of 1-10 cm.

10. The process for making a hollow fiber membrane with a PBI outer layer and a PEI inner layer according to claim 7 wherein the take-up speed being in the range of free fall (about 4.6) to 25 m/min.

11. The process for making a hollow fiber membrane with a PBI outer layer and a PEI inner layer according to claim 7 wherein the PBI dope comprises 20-30 wt % PBI in a solvent and the PEI dope comprises 20-30 wt % PEI in a solvent.

12. The process for making a hollow fiber membrane with a PBI outer layer and a PEI inner layer according to claim 7 wherein the bore quench fluid being a mixture of a solvent and non-solvent.

13. The process for making a hollow fiber membrane with a PBI outer layer and a PEI inner layer according to claim 7 wherein the coagulation bath comprising water.

14. A hollow fiber membrane contactor comprising: a shell and a hollow fiber module, said module being contained within said shell, and said module comprising a bundle of hollow fiber membranes according to claim 1 with a tube sheet located at the ends of said hollow fiber bundle.

15. A process for the dehydration of an organic liquid comprising the steps of:
feeding a water/organic liquid mixture to a first side of a hollow fiber membrane, the hollow fiber membrane comprising a microporous support layer, and a permselective layer of a polybenzimidazole (PBI),
drawing a vacuum on a second side of the hollow fiber membrane, and
collecting a permeate rich in water when compared to the water/organic liquid mixture from the first side of the hollow fiber membrane and a retentate rich in the organic liquid when compared to the water/organic liquid mixture from the second side of the hollow fiber membrane.

16. The process for the dehydration of an organic liquid according to claim 15 further comprising the steps of:
feeding a water/organic liquid mixture through one side of a hollow fiber membrane contactor, the hollow fiber membrane contactor comprising a plurality of hollow fiber membranes comprising a microporous support layer, and a permselective layer of a polybenzimidazole (PBI),
drawing a vacuum on another side of the hollow fiber membrane contactor, and
collecting a permeate rich in water when compared to the water/organic liquid mixture and a retentate rich in the organic liquid when compared to the water/organic liquid mixture.

17. The process of claim 16 wherein the support layer comprising polyetherimide (PEI).

18. The process of claim 16 wherein the support layer being an inner layer and the permselective layer being an outer layer.

19. The process of claim 16 wherein the one side being a shell side and the another side being a lumen side of the contactor.

20. The process for the dehydration of an organic liquid according to claim 16 wherein the organic liquid being ethylene glycol.
